(19) United States
(12) Patent Application Publication
(10) Pub. No.: US 2025/0094667 A1
(43) Pub. Date: Mar. 20, 2025

(54) UNIFIED PLATFORM FOR PLANNING AND OPERATIONS OF AN ELECTRIC POWER GRID

(71) Applicant: X Development LLC, Mountain View, CA (US)

(72) Inventors: Sze Mei Cat Wong, Johns Creek, GA (US); Leo Francis Casey, San Francisco, CA (US); Sushant Kumar, San Jose, CA (US)

(21) Appl. No.: 18/884,957

(22) Filed: Sep. 13, 2024

Related U.S. Application Data
(60) Provisional application No. 63/583,049, filed on Sep. 15, 2023.

(51) Int. Cl. G06F 30/20; G06F 113/04

(52) U.S. Cl. CPC G06F 30/20; G06F 2113/04

(57) ABSTRACT

Methods, systems, and apparatus, including computer programs encoded on a computer storage medium, for simulation of electrical power grid behaviors. In some instances, a data model associated with an electrical power grid is obtained. The data model stores static data and dynamic data that can be continuously integrated into the data model based on data streams obtained from data sources associated with properties of the electrical power grid. A set of interfaces can be instantiated for querying data based on the data model. The querying is related to data from at least one of a planning analysis modeling domain or an operation analysis modeling domain from the data model related to the electrical power grid. A query associated with a first planning operation in the planning analysis modeling domain is executed. The query defines one or more nodes of the electrical power grid and relates to the planning analysis domain.

### CROSS-REFERENCE TO RELATED APPLICATION

This application claims priority to U.S. Provisional Application No. 63/583,049, filed on Sep. 15, 2023. The disclosure of the prior application is considered part of and are incorporated by reference in the disclosure of this application.

### TECHNICAL FIELD

The present specification relates to electrical power grids, and specifically to performing planning and operational modeling of an electrical grid system.

### BACKGROUND

Electrical power grids transmit electrical power to loads such as residential and commercial buildings. Virtual models of an electrical grid can be used to simulate operations under various conditions.

### SUMMARY

Techniques are described for simulation of electrical power grid behaviors.

In general, the present disclosure relates to a platform that integrates planning and operation tools associated with an electric power grid so that they share a common data schema, data repositories and database views exposed through a common interface (or view). The common interface or view may be associated with different access right for different portions of the data for different user roles. In some cases, a user of an operator role may have access to a subset of the data that is different for a planner role. In some cases, based on security configurations for different user roles, different user roles may be associated with different actions. For example, some use roles may be provided with only view action rights, while other user roles may have view and edit action rights. Different subsets of data associated with different data properties accessible through the common view can be defined as accessible for users of different roles or groups.

An electrical power grid can undergo additions and/or changes on a continual basis. New buildings, renewable power plants, stationary storage, mobile storage, and expansions to existing buildings, facilities, and loads are some examples of potential changes that can be proposed and made to existing electrical systems, e.g., distribution feeders. As the electrical power grid becomes more complex and operating values approach critical limits, providing information for the electrical grid in different contexts become more important and more complex. Detailed interconnection studies can be performed to track operational characteristics of the power grid, to collect data for different nodes of the power grid, and also to align such data with data that is relevant for accurate planning execution. By providing an integrated platform for planning and operation tasks that share a common view of data related to the electrical power grid, the impacts of the interconnection between the different operations that are related with the same elements of the grid but in a different context or domain can be fully evaluated and further used to improve accuracy of the operation and planning task and also support continuous improvement process for evaluating the status of the electrical power grid.

Electrical grid models and respective data models can be used to evaluate and predict operations and potential faults in an electrical grid. Conventional planning and operation tools are separate and not aligned or interconnected to feed data between each other thus to be synchronized. Performing operation planning analysis can include analysis of the current topology of an electric power grid. Operation tools can support execution of actions related to nodes in the electric power grid (e.g., close or open a circuit breaker) and also can feed status (dynamic) data related to the electric power grid and/or historical data related to operations performed for the electric power grid as input data for executing planning tasks. In some cases, the topology of the electrical power grid can change (e.g., after a disruption such as due to a natural disaster or severe weather conditions) and some of the connections between the assets may be interrupted. In those cases, a planning analysis can be initiated based on a first action of obtaining information of the current state of the electrical power grid and working with the changed topology to perform planning actions (e.g., work on predictions of a future state).

An electrical grid model can be generated (e.g., as a virtual model) to include representations of existing real-world electrical grid components, representations of planned electrical grid components, or a combination of representations of existing and planned electrical grid components.

In some cases, a grid modeling and simulation system may perform a simulation in response to a request for simulation results that is provided through a user interface or an automatically triggered request. The request may be for output that shows the operational impacts of a change to the electrical grid, such as adding or removing an electrical power source or load. In some cases, the request may be for output that shows the operational impact of an event, such as a lightning strike or an outage of a power generating station connected to the electrical grid.

The simulation system can use a calibrated high resolution power grid model. The power grid model can include a model of the as-built grid, and can also include interconnections that have been approved but not yet built. The simulation system can use the power grid model to compare grid conditions prior to connection of the proposed interconnection to predicted grid conditions after connection of the proposed interconnection, in order to identify incremental effects of the interconnection.

This disclosure describes implementations that support integration of planning and operation tools through a common platform that integrates data from multiple sources to serve as a single source of truth that can be relied upon in both planning and operations use cases. For example, planning tools can access operation's historical data and identify patterns (e.g., ‘norms’ or ‘weak links’) in the system for managing an electric power grid's performance and use it as input for performing a planning analysis. The planning and operation tools as proposed are integrated to work with the same data model related to a physical model of the electric power grid. The data model can integrate data from different sources (e.g., sensors, external services (such weather provider, traffic status provider, etc.) and map different data points of the grid model (related to nodes of the grid) to different type of data related to different aspects of the electric power grid.

Other implementations of the above aspects include corresponding systems, apparatus, and computer programs, configured to perform the actions of the methods, encoded on computer storage devices. The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example computer system architecture that can be used to execute implementations of the present disclosure.

FIG. 2 is a flowchart for an example method for exposing interfaces to query an integrated data model view of operational and planning data in accordance with implementations of the present disclosure.

FIG. 3 is a flowchart for an example method for integrating input from planning into operations in accordance with implementations of the present disclosure.

FIG. 4 is a flowchart for an example method for optimizing an electrical power grid based on simulation of planning operations with real-time operational data in accordance with implementations of the present disclosure.

### DETAILED DESCRIPTION

In general, the present disclosure relates to performing planning and operational modeling of an electrical grid system.

Electrical power grids are interconnected networks of power sources, power loads, and power delivery and regulating components.

Conventional planning and operation tools are separate and not aligned or interconnected to feed data between each other thus to be synchronized. Performing operation planning analysis can include analysis of the current topology of an electric power grid. Operation tools can support execution of actions related to nodes in the electric power grid (e.g., close or open a circuit breaker) and also can feed status (dynamic) data related to the electric power grid and/or historical data related to operations performed for the electric power grid as input data for executing planning tasks.

This disclosure describes implementations that support integration of planning and operation tools through a common platform that integrates data from multiple sources to serve as a single source of truth that can be relied upon in both planning and operations use cases. For example, planning tools can access operation's historical data and identify patterns (e.g., ‘norms’ or ‘weak links’) in the system for managing an electric power grid's performance and use it as input for performing a planning analysis. In some cases, planning tools can access historical data to predict a future state of the electric power grid at a given point in time. The planning and operation tools as proposed are integrated to work with the same data model that represents a physical electric power grid. The data model can integrate data from different sources (e.g., sensors, imageries, surveys, physical inspections, data obtained from external services (such weather provider, traffic status provider, etc.) and map different data points of the grid model (related to nodes of the grid) to different type of data related to different aspects of the electric power grid.

In some instances, the integrated platform can expose a query view of the data model that can be used in the context of planning and/or operation activities. The query view can expose same or different type of data for a node of the electric power grid in the context of the type of the query. The integrated platform can support query executions that can relate different types of data for a given node of the electric power grid when perform planning analysis, operation task executions, and/or simulations in the context of planning or modifications of the model of the electric power grid.

In some instances, the integrated platform may support execution of operation and planning tasks related to either or both transmission or distribution aspects of electric power. Operational tools can rely on real time data from sensors and grid automation (automated control). The integrated platform can include different administrative groups and access/input limitations for different groups or user roles to facilitate task executions request by either planners or operators interacting with the data related to the electric power grid. In some cases, users of the integrated platform may not have direct access to the data related to the electric power grid in its raw form, for example, because of personal identifiable information considerations. In some of those cases, the data that can be provided to users can be processes data that is of allowable scope and is suitable for performing actions such as planning operations for the electric power grid. For example, operational users can control grid operations, but planning users can only view current operations and can execute simulations over defined planning models without having the rights to modify the grid model. Operations of an electric power grid can be simulated in accordance with a computer model of the grid.

In some implementations, electric grid assets may have different operating parameters or set points that are relevant for operations in during different states of the electric power grid. Data for the state of nodes of the grid can be collected as data streams from sensors or devices that monitor the physical status of the nodes. Such time series data can be used to define a current state of the electrical power grid as well as to generate averaged states that are more agnostic to temporary performance peaks and can better present the status over a predefined time span that reflects the regular behavior of the grid.

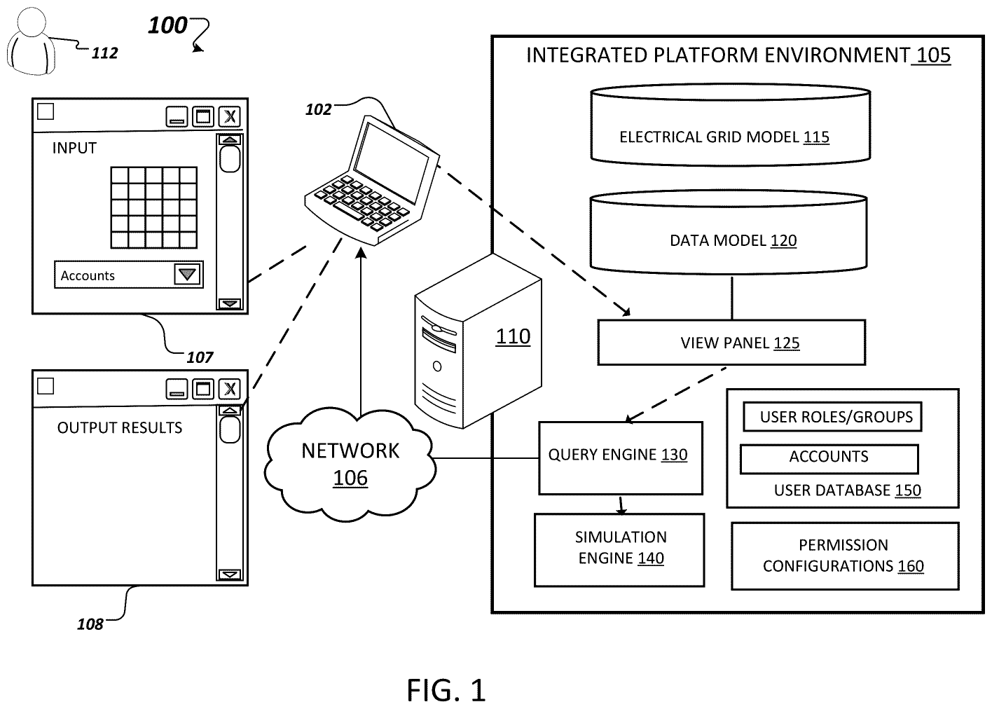

FIG. 1 illustrates an example computer system architecture that can be used to execute implementations of the present disclosure. The system 100 includes an integrated platform environment 105 that includes an electrical power grid model 115, a data model of the power grid 120, a view panel 125, a query engine 130, a simulation engine 140, a user database 150, and permission configuration 160.

In some instances, the view panel 125 can receive interactions from a user, such as user 112 with regard to queries related to execution operation and/or planning tasks.

In some instances, when a request is received at the view panel 125, the view panel 125 can generate a query based on obtaining data from the data model 120 of the electrical power grid, and execute the query at a query engine 120. The query engine can query data from the data model 120 and the electrical grid model 115 to provide a query result that can be output on the user interface. The query request can be associated with planning operations that defined one or more nodes of the power grid and relates to planning domain data from the data model 120.

In some implementations, after a query is executed and an output result is provided, a modification to the current state of the grid can be proposed, where such modification can be received as user input. Based on the proposed modification, a simulation of the behavior of the electrical power grid can be performed and a recommendation whether to adopt the modification or not can be provided based on the obtained simulation result. In some cases, the simulated behavior can be evaluated to determine whether the determined new performance of the grid associated with the modification is above the performance of the grid prior to the modification, for example, above the performance value with at least a threshold value. The view panel as well as the query engine 130 can communicate with the simulation engine 140 to serve requests from users and provide evaluations of the current and future state of the electrical power grid.

The simulation engine 140 can be provided as one or more computer executable software modules, hardware modules, or a combination thereof. For example, the simulation engine 120 can be implemented as blocks of software code with instructions that cause one or more processors of the simulation server 110 to execute operations described herein. In addition or alternatively, the simulation engine 120 can be implemented in electronic circuitry such as, e.g., programmable logic circuits, field programmable logic arrays (FPGA), or application specific integrated circuits (ASIC).

The integrated platform environment 110 may be part of a cloud computing platform. The integrated platform environment 110 can be maintained and operated, for example, by an administrator of the electrical power utility or by a third part.

The user device 102 can communicate with the integrated platform environment 110 over, for example, a network 106. The network 106 can include public and/or private networks and can include the Internet. The user device 102 can be an electronic device such as a computing device. The user device 102 can be, for example, a desktop computer, a laptop computer, a smart phone, a cell phone, a tablet, a PDA, etc.

The user device 102 can display both an input user interface 107 and an output user interface 108. The input user interface 107 can include an input form to enable a user to input a request, such as a query related to executing a planning operation or an operation analysis task. In general, a user can provide a request or query through an input user interface. The input user interface includes input fields for various data. For example, the input user interface includes an input field for a location, a change, a scenario, a data source, and requested output. In some examples, the input user interface 106 can include more or fewer input fields. The input user interface 106 can include input fields in various formats. For example, the input user interface 106 can include input fields with drop-down menus, slider icons, text input fields, maps, selectable icons, search fields, etc.

In some implementations, the electrical grid model 115 can include a high-resolution electrical model of one or more electrical distribution feeders. The electrical grid model 115 can include, for example, data models of substation transformers, distribution switches and reclosers, voltage regulation schemes, e.g., tapped magnetics or switched capacitors, network transformers, load transformers, inverters, generators, and various loads. The electrical grid model 115 can include line models, e.g., electrical models of medium voltage distribution lines. The electrical grid model 115 can also include electrical models of fixed and switched line capacitors, as well as other grid components and equipment.

The electrical grid model 115 can include a topological representation of a power grid or a portion of the power grid. The detail of the electrical grid model 115 can be sufficient to allow for accurate simulation and evaluation of the state of the electrical power grid.

The electrical grid model 115 can include different versions of the same electrical grid. Each version may represent the past, the present and the future states of the grid, including changes of topology over time such as introduction of new assets and changing of switch positions. This enables analyzing past behavior as well as a series of planned or hypothetical future scenarios. Different versions of the electrical grid model 115 can represent the intended grid design, the as-built design, the operational design, and future versions that represent combinations of planned and hypothetical equipment modifications, additions, removals, and replacements.

The electrical grid model 115 can adapt to differing levels of confidence, using machine learning to fill in gaps where model information is unknown or known with low confidence. For example, if provided connectivity data is insufficient, the model may augment automatically with connectivity information deduced from computer vision processing. For example, the electrical grid model 115 can include probabilistic models for the electrical properties of grid devices, power consumption, power generation, and asset failure based on estimated asset health.

In some implementations, the electrical grid model 115 can be associated with a data model 120. The data model 120 can include a set of elements organized into a hierarchical structure. The elements of the data model are mapped to at least portions of data obtained from at least two data streams for a node of the electrical power grid, where the data from the at least two data streams overlap in relation to a set of properties of the element.

In some implementations, when a query request is received at a view panel 125, where the query is for executing a planning operation, data from the data model 120 can be invoked, where the data is from a relevant domain for the operation.

In some implementations, the view panel 125 can include an interface from a set of interfaces that are predefined for different types of queries and use case scenarios. In some instances, the different interfaces can be associated with different sets of user group or user of different user roles. The set of interfaces can be predefined for a set of user groups including a planner user group and an operation user group. For example, the view panel 125 can include a first interface associated with a planner user group that is associated with a planning analysis modeling domain. In this example, at least a portion of data from the planning analysis modeling domain is accessible for editing by a user of the planner user group and is only accessible for viewing by a user of the operation user group. Further, at least a portion of data from the operation analysis modeling domain is accessible for editing by a user of the operation user group and is only accessible for viewing by a user of the planner user group.

In some instances, the functionality provided through the view panel 125 can be configured based on defined account for the integrated platform as well as access permissions configured for different user roles. In some instances, different access right can be provided at the integrated platform environment to different users of a certain user role for accessing particular portions of the data of the data model 120. In some cases, a user of an operator role may have access to a subset of the data that is different for a planner role. Different subsets of data associated with different data properties accessible through the common view can be defined as accessible for users of different roles or groups.

The integrated platform environment 105 stores data for users in a user database 150 including data for the user roles and/or groups of the users. Different accounts can be configured at the platform, and those accounts can include some or all of the defined roles for the platform. The access permissions can be set up on account level, on user role/group level, on an ad hoc configuration, or combination thereof. The platform environment 105 can store permission configurations 160 for data from the data model 120 and respective user roles/groups as defined in the user database 150.

In some implementations, simulations can be performed in relation to the behavior of the electric power grid which include different modification for at least portions of the grid. Such modification can be defined in view of the grid model 115. The data model 120 can derive probabilistic information from historical and current versions of the electrical power grid model 115 as defined in his current state and previous recorded states. For example, to predict effects of a future modification of the electrical power grid, effects of previous similar modifications to the electrical power grid can be considered as well as simulation of predefined test simulation scenarios can be executed that mimic critical or relevant use cases associated with previous states of the electrical power grid. The electrical grid model 115 can also incorporate and analyze historical data from electrical grids in various geographic locations. In this way, the electrical grid model 115 can use machine learning to identify trends and patterns in order to predict equipment performance in the future.

The electrical grid model 115 can be adaptive such that a change in one aspect of the electrical grid model 115 persists to all other aspects. For example, a new inverted-connected resource may be connected to the electrical power grid. The electrical grid model 115 can receive and incorporate data indicating the new resource. Such change in the electrical grid model 115 can be associated with a corresponding change for the data model 120 to track data related to the nodes of the electrical grid model 115.

The electrical grid model 115 can take into account the interdependency of energy systems beyond the electrical grid, such as the electrical elements of a natural gas storage, distribution and electrical generation system. The data model 120 can store data for nodes of the electrical grid model 115 and model their interaction with other systems. For example, a backup power systems interacting with primary power systems can be modeled relationship for primary power systems part of the grid model 115. For example, battery and solar powered systems may be replaceable by diesel generator systems. Detailed models of all interacting subsystems with associated simulations of all normal, abnormal and corner conditions can be performed.

The data model 120 can be calibrated by using measured electrical power grid data. The measured electrical power grid data can include historical grid operating data. The historical grid operating data can be collected during grid operation over a period of time, e.g., a number of weeks, months, or years. In some examples, the historical grid operating data can be average historical operating data. For example, historical grid operating data can include an electrical load on a substation during a particular hour of the year, averaged over multiple years. In another example, historical grid operating data can include a number of voltage violations of the electrical power grid during a particular hour of the year, possibly averaged over multiple years, or otherwise represented statistically.

In some examples, the data model 120 can include measured data for certain time intervals, e.g., certain hours, and might not include measured data for other time intervals for nodes of the electrical power grid. Based on evaluating data from the data model 120, calculations of assumptions to estimate or interpolate grid operating data for time intervals in which measurements are not available can be performed. An assumption can be, for example, an assumed relationship between loads at a particular location at nighttime compared to daytime, which can be based on evaluating of data related to the operational domain and associated with nodes of the electrical power grid at the particular location. In another example, an assumption can be an assumed relationship between loads at a particular location during an hour of the day in summertime, compared to during the same hour of the day in wintertime.

In some examples, the data model 120 can include measured data for certain characteristics, e.g., electrical load, and might not include measured data for other characteristics. The data model 120 can use assumptions to estimate grid operating data for characteristics for which measurements are not available. An assumption can be, for example, an assumed relationship between load and voltage at a particular location of the power grid.

The simulation engine 140 can define a configuration model for the electrical grid model 115, based on a received query request and a defined or obtained modification for the current state of the electrical grid model 115.

In some implementations, the simulation engine 140 includes a ruleset defining various combinations of user inputs for a simulation request and appropriate configuration models for each combination of user inputs to simulate the operations of the electrical power grid and provide a prediction for the state of the electrical power grid for certain modifications.

In some implementations, electric grid elements within the grid model 115 may have different operating parameters or set points that are relevant for operations in steady state than for operations during transients. Such parameters can be reflected in elements of the data model 120 that map to the electric grid elements within the grid model 115. For example, a breaker may have a time delay over current or over voltage trip that trips the breaker only after a short period of time (fractions of a second). The grid model 115 of the electrical power grid incorporates grid nodes and a loading model that can be used as a first class data set for execution of planning operations in the context of a planning scenario.

The various grid components in the computer model can include two more sets of operating parameters or set points, each step being relevant to a simulation in a different time resolution. The computer model can have separate operating parameters for each component in the steady-state and transient domains. For example, a generator's control settings can change or are at least simulated differently on different time scales.

The location in the power grid can include a geographic location identified by the simulation request 108. For example, the location can include a postal address or a latitude and longitude coordinate position.

The simulation engine 140 can then perform a series of simulations. The simulations can be based on, for example, root-mean-square (RMS), power flow, positive sequence, and/or time series voltage transient analysis. The amount of data processed during each simulation can depend on the size and framework of the portion of the gird that is being evaluated. The simulation can analyze predicted effects for all connections to the affected distribution feeder and all components of the affected distribution feeder. Thus, the complexity of simulations can vary depending on construction of the distribution feeder.

For example, the simulations can vary depending on length, power, and number of loads of a distribution feeder. A typical distribution feeder can range in length from approximately one mile to ten miles. A typical distribution feeder can range in power from approximately one to ten megawatts. The number of loads connected to a feeder can range from a few hundred residential loads to several thousand residential loads. In some cases, there may also be as few as a few dozen commercial or industrial loads, and as many as hundreds of commercial or industrial loads. A similar situation may also arise with respect to transmission lines. For instance, the simulation may vary depending on length depending on the length, power, and number of power sources on a transmission network. Likewise, simulations, simulation parameters, and electric grid topologies may differ widely based on the location (e.g., urban vs rural and in different countries) of the electric grid being simulated.

The construction of a distribution feeder can also vary based on location. In urban environments, residential loads typically share transformers. In rural environments, each residential load may have a separate transformer. Three-phase transformers typically serve commercial and industrial loads. Thus, the number of loads and transformers in a feeder could be as low as a few hundred loads with a few hundred transformers for a rural feeder. The number of loads and transformers in a feeder could be as many as thousands of loads with hundreds of single-phase transformers in an urban environment, coupled with dozens or hundreds of larger three phase loads and transformers.

In some examples, the simulation engine 140 can simulate operation of multiple feeders. For example, simulations can include analyses of operation of all feeders across a geographic region, e.g., a city, county, province, or state. In some cases, the simulation engine 120 can model operation of each individual feeder within the region, and can aggregate the results in order to model operation of the multiple feeders of the region.

The simulation engine 140 can analyze the expected operation of the power grid by applying empirical historical data to the grid model. The empirical historical data can include historical electrical grid characteristics based on, for example, measurements, calculations, estimates, and interpolations. The characteristics can include, for example, load, voltage, current, and power factor. The empirical historical data can represent power grid operation of multiple interconnected components within a designated geographical area. The empirical historical data can represent average electrical grid operating characteristics over a period of time, e.g., multiple weeks, months, or years.

In some examples, the simulations can cover a range of operating conditions, particularly under extremes of voltage from the Bulk Power System (BPS) and extremes in load on the electrical distribution feeder. The simulation engine 140 can simulate corner cases of the system with the proposed interconnection added to the existing system. The simulations can also cover electrical grid conditions during steady-state operation and during transient operation. The simulation engine 140 can accurately simulate operations of loads and sources, aggregated loads and sources, and disaggregated loads and sources.

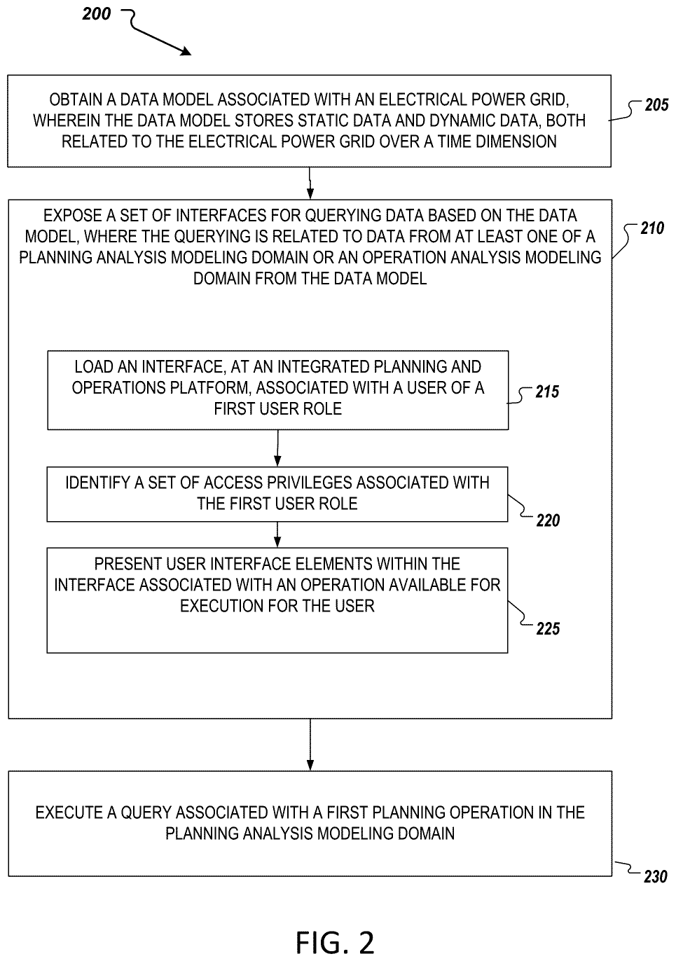

FIG. 2 is a flowchart for an example method 200 for exposing interfaces to query an integrated data model view of operational and planning data in accordance with implementations of the present disclosure. The method 200 can be executed at an integrated platform environment such as the integrated platform environment 110 of FIG. 1.

At 205, a data model associated with an electrical power grid is obtained. The data model can be substantially similar to the data model 120 of FIG. 1. The electrical power grid and its structure and topology can be modeled in a grid model, such as the electrical grid model 115 of FIG. 1. In some implementations, the data model stores static data and dynamic data, both related to the electrical power grid over a time dimension. The static and dynamic data are continuously integrated into the data model based on data streams obtained from a set of data sources associated with properties of the electrical power grid. In some instances, the data model stores a representation off the electric grid where the static data includes information about the location of assets of the electrical grid, connectivity between assets, parameters (e.g., rating, voltage level, etc.). The dynamic data can include time series data including historical status of assets (e.g., equipment) of the electrical grid, data for the power flow, data readings of voltage, current or else during a given time span.

At 210, a set of interfaces for querying data based on the data model are exposed. The set of interfaces can be exposed through a view panel of a platform such as the view panel 125 of FIG. 1. The interfaces can receive queries that are related to data from at least one of a planning analysis modeling domain or an operation analysis modeling domain from the data model related to the electrical power grid.

In some instances, the functionality for querying the data model can be configured for different users groups in a different way. For example, users of different roles may be provided with permissions to access different sets of data from the data model that are related to the tasks performed for the respective role.

For example, in a planning application scenario, a user of a planner role may be provided with direct access to meter data related to one or more assets of the electrical power grid to perform load modeling and prediction tasks.

At 215, an interface is loaded at the platform, for example, at an integrated planning and operations platform that provides integrated platform environment such as the integrated platform environment 110 of FIG. 1. The interface is associated with a user of a first user role of a plurality of roles defined at the integrated planning and operations platform.

At 220, a set of access privileges associated with the first user role are identified.

At 225, user interface elements are presented within the interface, where the elements associated with an operation available for execution for the user. The user interface elements can be mapped to respective elements of the data model that are accessible for the first user role.

At 230, a query associated with a first planning operation in the planning analysis modeling domain is executed. The query defines one or more nodes of the electrical power grid and relates to the planning analysis modeling domain. The executing of the query is based on data related to a current state of the electrical power grid defined based on data from the data model, the data being related to the one or more nodes of the electrical power grid in the operation analysis modeling domain.

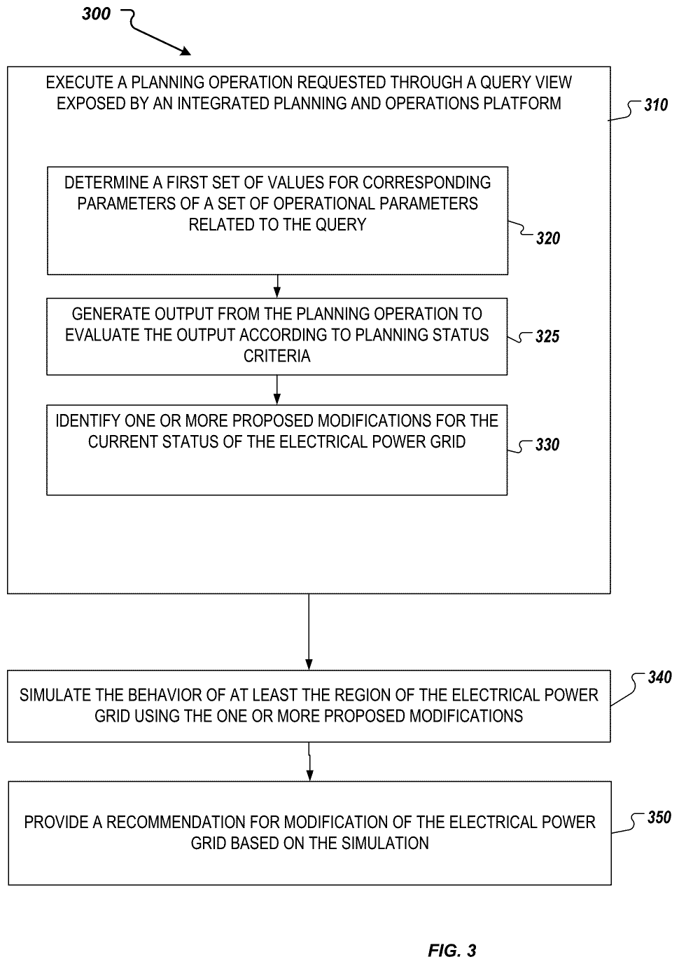

FIG. 3 is a flowchart for an example method 300 for integrating input from planning into operations in accordance with implementations of the present disclosure. The method 300 can be executed at an integrated platform environment such as the integrated platform environment 110 of FIG. 1.

At 310, a planning operation requested through a query view exposed by an integrated planning and operations platform is executed. The planning operation is related to a behavior of at least a region of an electrical power grid. The query view that is exposed by the platform (e.g., similarly to the query view of FIG. 1 and FIG. 2) can be exposed based on a data model that integrates planning and operational data associated with the electrical power grid. The data model can be substantially similar to the data model 120 of FIG. 1. The planning operation is executed based on data related to a current status of the electrical power grid determined based on the data model. The execution of the planning operation can include the following operations.

At 315, a first set of values for corresponding parameters of a set of operational parameters related to the query are determined. The first set of values is associated with a first time dimension.

At 320, output from the planning operation is generated, where the output is evaluated according to planning status criteria.

At 325, one or more proposed modifications for the current status of the electrical power grid are identified based on the evaluation of the output according to the planning status criteria.

At 330, the behavior of at least the region of the electrical power grid is simulated using the one or more proposed modifications.

At 335, a recommendation for a modification of the electrical power grid based on the simulation can be provided.

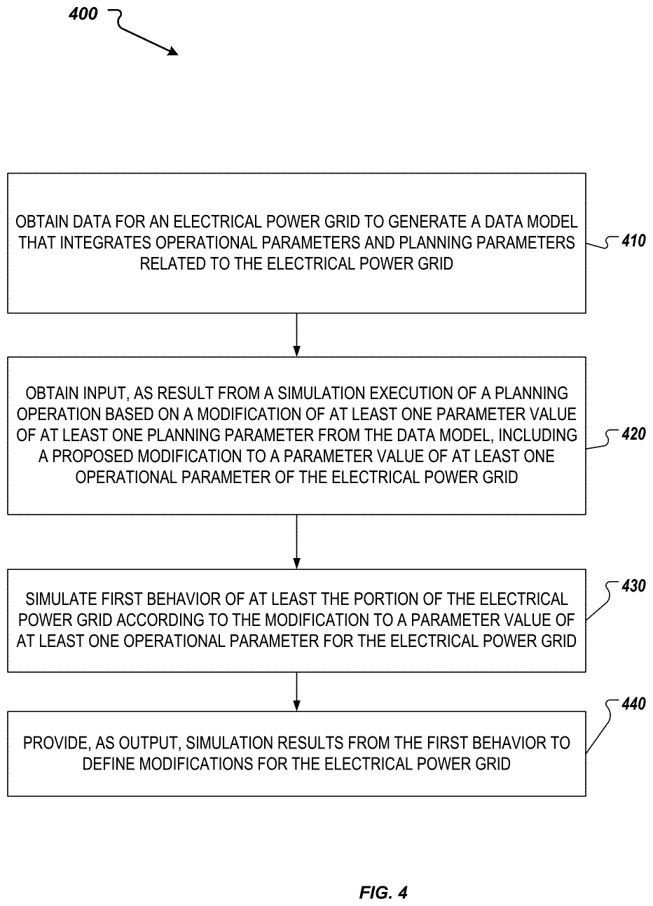

FIG. 4 is a flowchart for an example method for optimizing an electrical power grid based on simulation of planning operations with real-time operational data in accordance with implementations of the present disclosure. The method 400 can be executed at an integrated platform environment such as the integrated platform environment 110 of FIG. 1.

At 410, data for an electrical power grid is obtained to generate a data model that integrates operational parameters and planning parameters related to the electrical power grid. The data model can be substantially similar to the data model discussed in relation to FIGS. 1, 2, and 3. The electrical power grid is defined with a grid model (such as the electrical grid model 115 of FIG. 1) that interconnects grid nodes in a graph structure.

At 420, input is obtained as result from a simulation execution of a planning operation based on a modification of at least one parameter value of at least one planning parameter from the data model of the electrical power grid. The execution of the simulation can be substantially similar to the discussed simulation at FIG. 3 and in relation to operations 325 and 330. The obtained input at 415 can include a proposed modification to a parameter value of at least one operational parameter for at least one grid node of the electrical power grid. For example, such input can be received through the view panel of FIG. 1.

At 430, a first behavior of at least the portion of the electrical power grid is simulated according to the modification to a parameter value of at least one operational parameter for at least one grid node of the grid model.

At 440, simulation results from the first behavior are provided as output, where the output can include defines modifications for the electrical power grid that can result in an improved state of the electrical power grid.

This disclosure generally describes computer-implemented methods, software, and systems for electrical power grid visualization. A computing system can receive various electrical power grid data from multiple sources. Power grid data can include different temporal and spatially dependent characteristics of a power grid. The characteristics can include, for example, power flow, voltage, power factor, feeder utilization, and transformer utilization. These characteristics can be coupled; for example, some characteristics may influence others and/or their temporal and spatial dependence may be related.

Data sources can include satellites, aerial image databases, publicly available government power grid databases, and utility provider databases. The sources can also include sensors installed within the electrical grid by the grid operator or by others, e.g., power meters, current meters, voltage meters, or other devices with sensing capabilities that are connected to the power grid. Data sources can include databases and sensors for both high voltage transmission and medium voltage distribution and low voltage utilization systems.

The data can include, but is not limited to, map data, transformer locations and capacities, feeder locations and capacities, load locations, or a combination thereof. The data can also include measured data from various points of the electrical grid, e.g., voltage, power, current, power factor, phase, and phase balance between lines. In some examples, the data can include historical measured power grid data. In some examples, the data can include real-time measured power grid data. In some examples, the data can include simulated data. In some examples, the data can include a combination of measured and simulated data.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any system or on the scope of what may be claimed, but rather as descriptions of features that may be specific to particular implementations of particular systems. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art.

For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

Although the present application is defined in the attached claims, it should be understood that the present invention can also (additionally or alternatively) be defined in accordance with the following examples:
Example 1: A computer implemented method comprising: obtaining a data model associated with an electrical power grid, wherein the data model stores static data and dynamic data, both related to the electrical power grid over a time dimension, and wherein the static and dynamic data are continuously integrated into the data model based on data streams obtained from a set of data sources associated with properties of the electrical power grid; exposing a set of interfaces for querying data based on the data model, wherein the querying is related to data from at least one of a planning analysis modeling domain or an operation analysis modeling domain from the data model related to the electrical power grid; and executing a query associated with a first planning operation in the planning analysis modeling domain, wherein the query defines one or more nodes of the electrical power grid and relates to the planning analysis modeling domain, and wherein executing the query is based on data related to a current state of the electrical power grid defined based on data from the data model, the data being related to the one or more nodes of the electrical power grid in the operation analysis modeling domain.
Example 2. The method of Example 1, wherein obtaining the data model comprises: generating the data model associated with the electrical power grid by defining elements of the data model to map to properties of the electrical power grid, wherein the properties are associated with nodes of the electrical power grid and a topology of the electrical power grid.
Example 3. The method of any one of the preceding Examples, wherein the data model includes a set of elements organized into a hierarchical structure, wherein an element of the data model is mapped with data obtained from at least two data streams for a node of the electrical power grid, where the data from the at least two data streams overlap in relation to a set of properties of the element.
Example 4. The method of any one of the preceding Examples, wherein obtaining the data model comprises:
obtaining data from each source of the set of data sources, wherein a data source is associated with a node of the electrical power grid, wherein the data source is a sensor installed for a switch node part of the electrical power grid, wherein the sensor provides real-time sensor data as time series data collected over a first time period.
Example 5. The method of any one of the preceding Examples, wherein exposing the set of interfaces comprises:
loading an interface, at an integrated planning and operations platform, associated with a user of a first user role of a plurality of roles defined at the integrated planning and operations platform;
identifying a set of access privileges associated with the first user role; and
presenting user interface elements within the interface associated with an operation available for execution for the user, wherein the user interface elements map to respective elements of the data model, the elements being accessible for the first user role.
Example 6. The method of any one of the preceding Examples, wherein obtaining the data model comprises defining the data model according to a current topology of the electrical power grid, wherein the method further comprises:
obtaining data for nodes defined in the current topology of the electrical power grid;
receiving an update for the current topology of the electrical power grid, the update being associated with at least one current node of the electrical power grid and/or an additional node to modify the topology of the electrical power grid;
performing a simulation of the performance of the electrical power grid with an updated topology to determine a status of the electrical power grid associated with the update; and
providing instructions for modifying the electrical power grid in response to determining that the status of the electrical power grid associated with the update in the current topology is associated with a successful performance.
Example 7. The method of Example 6, the method comprising:
in response to determining that the status of the electrical power grid is associated with unacceptable performance, further modifying the current topology to include the received update and to include a further update to the electrical power grid to compensate for the received update; and
in response to determining a new status of the electrical power grid after the further modification that is associated with a successful performance, providing instructions to modify the electrical power grid according to the received update and the further update.
Example 8. The method of any one of the preceding Examples, wherein the set of interfaces are predefined for a set of user groups, the user groups including a planner user group and an operation user group, wherein a first interface associated with a planner user group is associated with a planning analysis modeling domain, wherein at least a portion of data from the planning analysis modeling domain is accessible for editing by a user of the planner user group and is only accessible for viewing by a user of the operation user group, and wherein at least a portion of data from the operation modeling domain is accessible for editing by a user of the operation user group and is only accessible for viewing by a user of the planner user group.
Example 9. A non-transitory, computer-readable medium coupled to one or more processors and having instructions stored thereon which, when executed by the one or more processors, cause the one or more processors to perform operations according to the method of any one of Examples 1 to 8.
Example 10. A system comprising:
a computing device; and
a computer-readable storage device coupled to the computing device and having instructions stored thereon which, when executed by the computing device, cause the computing device to perform operations according to the method of any one of the Examples 1 to 8.
Example 11. A computer implemented method comprising:
executing a planning operation requested through a query view exposed by an integrated planning and operations platform, wherein the planning operation is related to a behavior of at least a region of an electrical power grid, wherein the query view is based on a data model that integrates planning and operational data associated with the electrical power grid, wherein the planning operation is executed based on data related to a current status of the electrical power grid determined based on the data model, wherein executing the planning operation comprises:
   determining a first set of values for corresponding parameters of a set of operational parameters related to the query, wherein the first set of values is associated with a first time dimension;
   generating output from the planning operation to evaluate the output according to planning status criteria; and
   identifying one or more proposed modifications for the current status of the electrical power grid based on the evaluation of the output according to the planning status criteria;
simulating the behavior of at least the region of the electrical power grid using the one or more proposed modifications; and
providing a recommendation for modification of the electrical power grid based on the simulation.
Example 12. The method of Example 11, the method comprising:
instantiating the integrated planning and operations platform to expose views of the data model associated with corresponding types of tasks to be performed in relation to the electrical power grid, wherein the types of tasks include operations tasks and planning tasks.
Example 13. The method of Example 11 or Example 12, wherein the data model stores static data and dynamic data, both related to the electrical power grid over a time dimension, and wherein the static and dynamic data are continuously integrated into the data model based on data streams obtained from a set of data sources associated with properties of the electrical power grid.
Example 14. The method of any one of Examples 11 to 13, the method comprising:
exposing a set of interfaces for querying data based on the data model, wherein the querying is related to data from at least one of a planning analysis modeling domain from the data model related to the electrical power grid, wherein the query view is embedded in at least one interface of the set of interfaces.
Example 15. The method of any one of Examples 11 to 14, wherein determining the first set of values comprises:
generating and executing a query associated with the planning operation in a planning analysis modeling domain of the data model, wherein the query defines one or more nodes of the electrical power grid and relates to the planning analysis modeling domain, and wherein executing the query is based on data related to the current state of the electrical power grid defined based on data from the data model, the data being related to the one or more nodes of the electrical power grid in the operation analysis modeling domain.
Example 16. The method of any of Examples 11 to 15, wherein the data model includes a set of elements organized into a hierarchical structure, wherein an element of the data model is mapped with data obtained from at least two data streams for a node of the electrical power grid, where the data from the at least two data streams overlap in relation to a set of properties of the element.
Example 17. The method of Example 14, wherein the set of interfaces are predefined for a set of user groups, the user groups including a planner user group and an operation user group, wherein a first interface associated with a planner user group is associated with a planning analysis modeling domain, wherein at least a portion of data from the planning analysis modeling domain is accessible for editing by a user of the planner user group and is only accessible for viewing by a user of the operation user group, and wherein at least a portion of data from the operation modeling domain is accessible for editing by a user of the operation user group and is only accessible for viewing by a user of the planner user group.
Example 18. A non-transitory, computer-readable medium coupled to one or more processors and having instructions stored thereon which, when executed by the one or more processors, cause the one or more processors to perform operations according to the method of any one of Examples 11 to 17.
Example 19. A system comprising:
a computing device; and
a computer-readable storage device coupled to the computing device and having instructions stored thereon which, when executed by the computing device, cause the computing device to perform operations according to the method of any one of Examples 11 to 17.
Example 20. A computer implemented method for managing an electrical power grid, the method comprising:
obtaining data for an electrical power grid to generate a data model that integrates operational parameters and planning parameters related to the electrical power grid, wherein the electrical power grid is defined with a grid model that interconnects grid nodes in a graph structure;
obtaining input, as result from a simulation execution of a planning operation based on a modification of at least one parameter value of at least one planning parameter from the data model of the electrical power grid, including a proposed modification to a parameter value of at least one operational parameter for at least one grid node of the electrical power grid;
simulating first behavior of at least the portion of the electrical power grid according to the modification to a parameter value of at least one operational parameter for at least one grid node of the grid model; and
providing, as output, simulation results from the first behavior to define modifications for the electrical power grid.
Example 21. The method of Example 20, the method comprising:
generating the data model that includes a set of elements organized into a hierarchical structure.
Example 22. The method of any one of Examples 20 to 21, wherein the data model is generated based on data streams associated with each of the grid nodes of the grid model, wherein at least one grid node is associated with at least two data streams overlap in relation to a set of properties of an element of the data model.
Example 23. The method of any one of Examples 20 to 22, wherein an element of the data model is mapped with data obtained from at least two data streams for a node of the grid model, the node of the electrical power grid being mapped to a grid node of the grid mode.
Example 24. The method of any one of the Examples 20 to 23, wherein the grid model is used to evaluate and predict operations and performance of the electrical power grid.
Example 25. The method of any one of Examples 20 to 24, comprising:
executing a simulation of the planning operation based on the modification of the at least one parameter value of at least one planning parameter from the data model of the electrical power grid; and
determining at least one new parameter value of the at least planning parameter from the data model that is associated with an improved status for the planning operation, wherein the at least one new parameter value is used to the first behavior of at least the portion of the electrical power grid.
Example 26. The method of any one of Examples 20 to 25, further comprising:
in response to evaluating the simulation result from simulating the first behavior,
   defining a modification to the electrical power grid to include adding a grid node to the electrical power grid, wherein adding the grid node includes updating the grid model to define relationships between the added grid node and at least a portion of the grid nodes of the electrical power grid, and
   configuring the added node according to a new parameter value of a parameter of the at least one operational parameter in accordance with the simulation results.
Example 27. A non-transitory, computer-readable medium coupled to one or more processors and having instructions stored thereon which, when executed by the one or more processors, cause the one or more processors to perform operations according to the method of any one of Examples 20 to 26.
Example 28. A system comprising
a computing device; and
a computer-readable storage device coupled to the computing device and having instructions stored thereon which, when executed by the computing device, cause the computing device to perform operations according to the method of any one of Examples 20 to 26.

1. A computer implemented method comprising:
executing a planning operation requested through a query view exposed by an integrated planning and operations platform, wherein the planning operation is related to a behavior of at least a region of an electrical power grid, wherein the query view is based on a data model that integrates planning and operational data associated with the electrical power grid, wherein the planning operation is executed based on data related to a current status of the electrical power grid determined based on the data model, wherein executing the planning operation comprises:
determining a first set of values for corresponding parameters of a set of operational parameters related to the requested planning operation, wherein the first set of values is associated with a first time dimension;
generating output from the planning operation to evaluate the output according to planning status criteria; and
identifying one or more proposed modifications for the current status of the electrical power grid based on the evaluation of the output according to the planning status criteria;
simulating the behavior of at least the region of the electrical power grid using the one or more proposed modifications; and
providing a recommendation for modification of the electrical power grid based on the simulation.

2. The method of claim 1, the method comprising:
instantiating the integrated planning and operations platform to expose views of the data model associated with corresponding types of tasks to be performed in relation to the electrical power grid, wherein the types of tasks include operations tasks and planning tasks.

3. The method of claim 1, wherein the data model stores static data and dynamic data, both related to the electrical power grid over a time dimension, and wherein the static data and the dynamic data are continuously integrated into the data model based on data streams obtained from a set of data sources associated with properties of the electrical power grid.

4. The method of claim 1, the method comprising:
exposing a set of interfaces for querying data based on the data model, wherein the querying is related to data from at least one of a planning analysis modeling domain from the data model related to the electrical power grid, wherein the query view is embedded in at least one interface of the set of interfaces.

5. The method of claim 1, wherein determining the first set of values comprises:
generating and executing a query associated with the planning operation in a planning analysis modeling domain of the data model, wherein the query defines one or more nodes of the electrical power grid and relates to the planning analysis modeling domain, and wherein executing the query is based on data related to a current state of the electrical power grid defined based on data from the data model, the data being related to the one or more nodes of the electrical power grid in an operation analysis modeling domain.

6. The method of claim 1, wherein the data model includes a set of elements organized into a hierarchical structure, wherein an element of the data model is mapped with data obtained from at least two data streams for a node of the electrical power grid, where the data from the at least two data streams overlap in relation to a set of properties of the element.

7. The method of claim 4, wherein the set of interfaces are predefined for a set of user groups, the user groups including a planner user group and an operation user group, wherein a first interface associated with a planner user group is associated with a planning analysis modeling domain, wherein at least a portion of data from the planning analysis modeling domain is accessible for editing by a user of the planner user group and is only accessible for viewing by a user of the operation user group, and wherein at least a portion of data from an operation analysis modeling domain is accessible for editing by a user of the operation user group and is only accessible for viewing by a user of the planner user group.

8. A non-transitory, computer-readable medium coupled to one or more processors and having instructions stored thereon which, when executed by the one or more processors, cause the one or more processors to perform operations comprising:
executing a planning operation requested through a query view exposed by an integrated planning and operations platform, wherein the planning operation is related to a behavior of at least a region of an electrical power grid, wherein the query view is based on a data model that integrates planning and operational data associated with the electrical power grid, wherein the planning operation is executed based on data related to a current status of the electrical power grid determined based on the data model, wherein executing the planning operation comprises:
determining a first set of values for corresponding parameters of a set of operational parameters related to the requested planning operation, wherein the first set of values is associated with a first time dimension;
generating output from the planning operation to evaluate the output according to planning status criteria; and
identifying one or more proposed modifications for the current status of the electrical power grid based on the evaluation of the output according to the planning status criteria;
simulating the behavior of at least the region of the electrical power grid using the one or more proposed modifications; and
providing a recommendation for modification of the electrical power grid based on the simulation.

9. The non-transitory, computer-readable medium of claim 8, comprising further instructions which, when executed by the one or more processors, cause the one or more processors to perform operations, comprising:
instantiating the integrated planning and operations platform to expose views of the data model associated with corresponding types of tasks to be performed in relation to the electrical power grid, wherein the types of tasks include operations tasks and planning tasks.

10. The non-transitory, computer-readable medium of claim 8, wherein the data model stores static data and dynamic data, both related to the electrical power grid over a time dimension, and wherein the static data and the dynamic data are continuously integrated into the data model based on data streams obtained from a set of data sources associated with properties of the electrical power grid.

11. The non-transitory, computer-readable medium of claim 8, comprising further instructions which, when executed by the one or more processors, cause the one or more processors to perform operations, comprising:
exposing a set of interfaces for querying data based on the data model, wherein the querying is related to data from at least one of a planning analysis modeling domain from the data model related to the electrical power grid, wherein the query view is embedded in at least one interface of the set of interfaces.

12. The non-transitory, computer-readable medium of claim 8, wherein determining the first set of values comprises:
generating and executing a query associated with the planning operation in a planning analysis modeling domain of the data model, wherein the query defines one or more nodes of the electrical power grid and relates to the planning analysis modeling domain, and wherein executing the query is based on data related to a current state of the electrical power grid defined based on data from the data model, the data being related to the one or more nodes of the electrical power grid in an operation analysis modeling domain.

13. The non-transitory, computer-readable medium of claim 8, wherein the data model includes a set of elements organized into a hierarchical structure, wherein an element of the data model is mapped with data obtained from at least two data streams for a node of the electrical power grid, where the data from the at least two data streams overlap in relation to a set of properties of the element.

14. The non-transitory, computer-readable medium of claim 11, wherein the set of interfaces are predefined for a set of user groups, the user groups including a planner user group and an operation user group, wherein a first interface associated with a planner user group is associated with a planning analysis modeling domain, wherein at least a portion of data from the planning analysis modeling domain is accessible for editing by a user of the planner user group and is only accessible for viewing by a user of the operation user group, and wherein at least a portion of data from the operation analysis modeling domain is accessible for editing by a user of the operation user group and is only accessible for viewing by a user of the planner user group.

15. A system comprising
a computing device; and
a computer-readable storage device coupled to the computing device and having instructions stored thereon which, when executed by the computing device, cause the computing device to perform operations comprising:
executing a planning operation requested through a query view exposed by an integrated planning and operations platform, wherein the planning operation is related to a behavior of at least a region of an electrical power grid, wherein the query view is based on a data model that integrates planning and operational data associated with the electrical power grid, wherein the planning operation is executed based on data related to a current status of the electrical power grid determined based on the data model, wherein executing the planning operation comprises:
determining a first set of values for corresponding parameters of a set of operational parameters related to the requested planning operation, wherein the first set of values is associated with a first time dimension;
generating output from the planning operation to evaluate the output according to planning status criteria; and
identifying one or more proposed modifications for the current status of the electrical power grid based on the evaluation of the output according to the planning status criteria;
simulating the behavior of at least the region of the electrical power grid using the one or more proposed modifications; and
providing a recommendation for modification of the electrical power grid based on the simulation.

16. The system of claim 15, wherein the computer-readable storage device has further instructions which, when executed by the computing device, cause the computing device to perform operations, comprising:
instantiating the integrated planning and operations platform to expose views of the data model associated with corresponding types of tasks to be performed in relation to the electrical power grid, wherein the types of tasks include operations tasks and planning tasks.

17. The system of claim 15, wherein the data model stores static data and dynamic data, both related to the electrical power grid over a time dimension, and wherein the static data and the dynamic data are continuously integrated into the data model based on data streams obtained from a set of data sources associated with properties of the electrical power grid.

18. The system of claim 15, wherein the computer-readable storage device has further instructions which, when executed by the computing device, cause the computing device to perform operations, comprising:
exposing a set of interfaces for querying data based on the data model, wherein the querying is related to data from at least one of a planning analysis modeling domain from the data model related to the electrical power grid, wherein the query view is embedded in at least one interface of the set of interfaces.

19. The system of claim 15, wherein determining the first set of values comprises:
generating and executing a query associated with the planning operation in a planning analysis modeling domain of the data model, wherein the query defines one or more nodes of the electrical power grid and relates to the planning analysis modeling domain, and wherein executing the query is based on data related to a current state of the electrical power grid defined based on data from the data model, the data being related to the one or more nodes of the electrical power grid in an operation analysis modeling domain.

20. The system of claim 19, wherein the data model includes a set of elements organized into a hierarchical structure, wherein an element of the data model is mapped with data obtained from at least two data streams for a node of the electrical power grid, where the data from the at least two data streams overlap in relation to a set of properties of the element.
